(19) United States
(12) Patent Application Publication
(10) Pub. No.: US 2004/0123278 A1
(43) Pub. Date: Jun. 24, 2004

(54) Persistent cache apparatus and methods

(76) Inventors: Murthi Nanja, Portland, OR (US); Randall E. Hall, Gilbert, AZ (US)

Correspondence Address: GROSSMAN & FLIGHT LLC, Suite 4220, 20 North Wacker Drive, Chicago, IL, 60606-6357, US

(21) Appl. No.: 10/327,848

(22) Filed: Dec. 23, 2002

(51) Int. Cl. G06F 9/45

(52) U.S. Cl. 717/153; 717/148

(57) ABSTRACT

Persistent cache apparatus and methods are disclosed. An apparatus and method for caching machine code receives intermediate language code in a just-in-time compiler and just-in-time compiles the intermediate language code to generate machine code. The apparatus and method stores the machine code in a non-persistent cache within a runtime environment and also stores the machine code in a persistent cache coupled to the runtime environment.

### FIELD OF THE DISCLOSURE

The present disclosure relates generally to managed runtime environments and, more specifically, to persistent cache apparatus and methods for use in managed runtime environments.

### BACKGROUND

The need for increased software application portability (i.e., the ability to execute a given software application on a variety of platforms having different hardware, operating systems, etc.) as well as the need to reduce time to market for independent software vendors (ISVs), have resulted in increased development and usage of managed runtime environments.

Managed runtime environments are typically implemented using a dynamic programming language such as, for example, Java and C#. A software engine (e.g., a Java Virtual Machine (JVM), Common Language Runtime (CLR), etc.), which is commonly referred to as a runtime environment, executes the dynamic program language instructions. The runtime environment interposes or interfaces between dynamic program language instructions (e.g., a Java program) to be executed and the target execution platform (i.e., the hardware and operating system(s) of the computer executing the dynamic program) so that the dynamic program can be executed in a platform independent manner.

Dynamic program language instructions (e.g., Java instructions, C# instructions, etc.) are not statically compiled and linked directly into native or machine code for execution by the target platform (i.e., the operating system and hardware of the target processing system or platform). Instead, dynamic program language instructions are statically compiled into an intermediate language (e.g., bytecodes) and the intermediate language is subsequently compiled by a just-in-time (JIT) compiler into native or machine code that can be executed by the target processing system or platform. Typically, the JIT compiler is provided by a runtime environment that is hosted by the operating system of a target processing platform such as, for example, a computer system. Thus, the runtime environment and, in particular, the JIT compiler, functions to translate platform independent program instructions (e.g., Java instructions, C# instructions, etc.) into native code (i.e., machine code that can be executed by an underlying target processing system or platform).

To improve the overall performance of a dynamic programming language, many managed runtime environments configure their JIT compiler so that it does not have to compile an entire software application at one time prior to executing the application. Instead, only the software objects or methods of the application that are currently needed for execution are compiled by the JIT compiler and then executed by the target processing system or platform. While this partial compilation technique can improve performance, the rate at which a JIT compiler generates native machine code from intermediate language code has an even greater impact on the overall performance (e.g., execution speed) of a dynamic or platform independent programming language.

To improve the rate at which native machine code is generated, many JIT compilers store compiled intermediate language (i.e., native code) in an internal or in-memory cache. In this manner, the internal caching structure of the JIT compiler eliminates the need to recompile previously compiled methods or objects that may be frequently invoked such as, for example, when repetitive calls to an application method are required.

Unfortunately, the internal or in-memory caching used by many managed runtime environments is not persistent following the ending of a runtime session, a system reboot, or the like. In other words, with these known in-memory caching mechanisms, following a runtime session, a system reboot, etc., cached code is lost and the JIT compiler must re-compile any objects or methods that are needed for execution, regardless of whether those objects or methods were compiled during an earlier runtime session.

### BRIEF DESCRIPTION OF THE DRAWINGS

FIG. 1 is a block diagram of an example architecture that may be used to implement the persistent cache apparatus and methods described herein;

FIG. 2 is a flow diagram of an example manner in which the just-in-time compiler and persistent cache engine shown in FIG. 1 may be configured;

FIG. 3 is a flow diagram of an example manner in which the persistent cache engine shown in FIG. 1 may be configured to generate identifiers for native code cached within the persistent cache;

FIG. 4 illustrates example pseudo-code that may be used to generate a hash code for use as a native code identifier; and

FIG. 5 is a block diagram of an example processor system that uses the apparatus and methods described herein.

### DETAILED DESCRIPTION

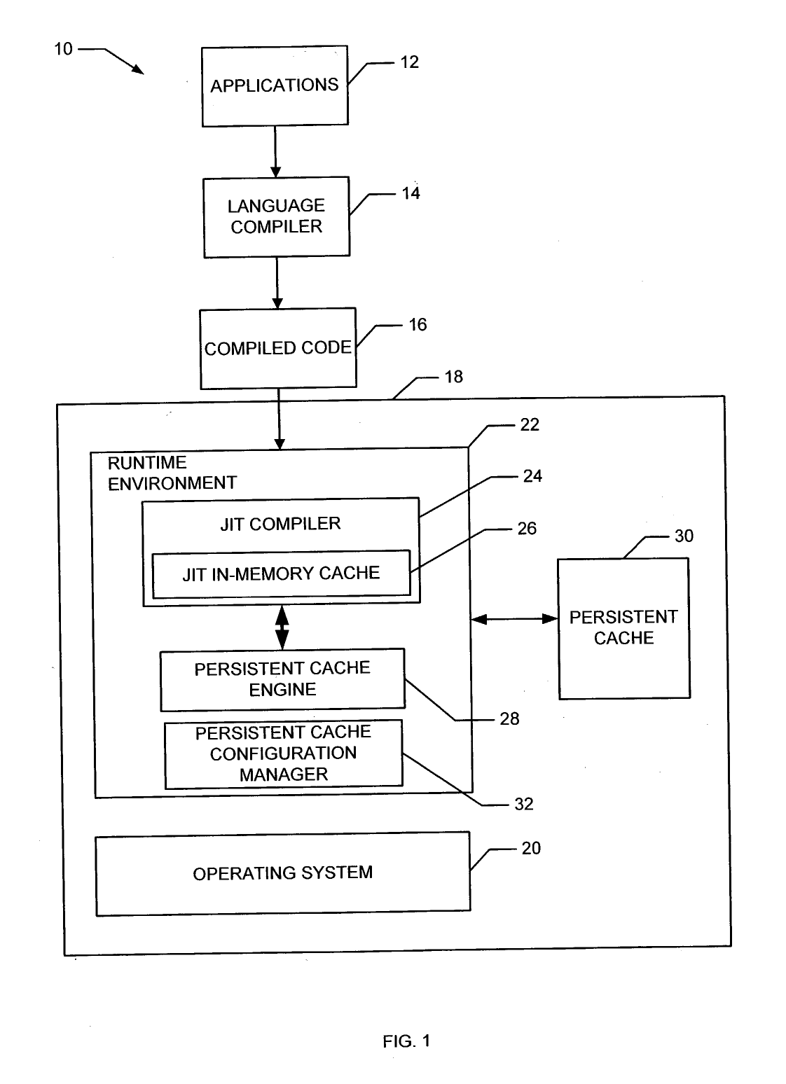

FIG. 1 is a block diagram of an example architecture 10 that may be used to implement the persistent cache apparatus and methods described herein. For the example architecture 10, one or more software applications 12, which are composed of one of more dynamic programming languages and/or instructions, are provided to a language compiler 14. The applications 12 may be written using a platform independent language such as, for example, Java or C#. However, any other dynamic or platform independent computer language or instructions could be used instead. In addition, some or all of the applications 12 may be stored within the system on which the applications are to be executed. Additionally or alternatively, some or all of the applications may be stored on a system that is separate (and possibly remotely located) from the system on which the applications 12 are to be executed.

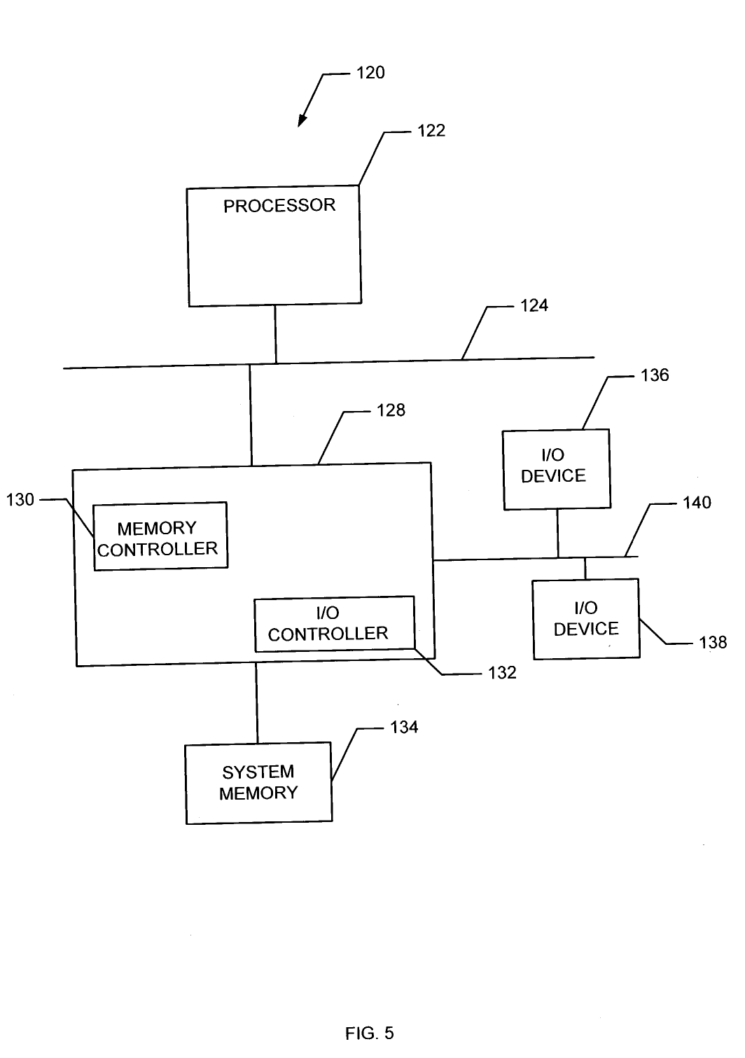

The language compiler 14 statically compiles one or more of the applications 12 to generate compiled code 16. The compiled code 16 is intermediate language code or instructions (e.g., bytecodes in the case where the complied application(s) are written in Java) that is stored in a binary format in a memory (not shown). As with the applications 12, the compiled code 16 may be stored locally on a target system 18, on which the compiled code 16 is to be executed. The target system 18 may be a computer system or the like such as that described in greater detail below in connection with FIG. 5. The target system 18 may be associated with one or more end-users or the like. Additionally or alternatively, the compiled code 16 may be delivered to the target system 18 via a communication link or links including, for example, a local area network, the Internet, a cellular or other wireless communication system, etc.

One or more portions of the compiled code 16 (e.g., one or more software applications) may be executed by the target system 18. In particular, an operating system 20 such as, for example, Windows, Linux, etc., hosts a runtime environment 22 that executes one or more portions of the compiled code 16. For example, in the case where the compiled code 16 includes Java bytecodes, the runtime environment 22 is based on a Java Virtual Machine (JVM) or the like that executes Java bytecodes. The runtime environment 22 loads one or more portions of the compiled code 16 (i.e., the intermediate language instructions or code) into a memory (not shown) accessible by the runtime environment 22. Preferably, the runtime environment 18 loads an entire application (or possibly multiple applications) into the memory and verifies the compiled or intermediate language code 16 for type safety.

After the application or multiple applications are loaded into memory by the runtime environment 22, the intermediate language instructions associated with methods or objects called by the application being executed or otherwise needed to execute the application are processed by a just-in-time (JIT) compiler 24. The JIT compiler 24 compiles the intermediate language instructions to generate native or machine code that is executed by one or more processors (such as, for example, the processor 122 shown in FIG. 5) within the computer system 18.

Preferably, the JIT compiler 24 stores native code (i.e., machine code compatible with and, thus executable by, the computer system 18) in a JIT in-memory cache (JIT IMC) 26. In this manner, the runtime environment 22 can re-use native code associated with a previously compiled method that is invoked or called more than once. In other words, intermediate language instructions compiled into native code and stored in the JIT IMC 26 can be re-used and executed multiple times by the runtime environment 22. However, the JIT IMC 26 is a non-persistent cache and, thus, does not retain data following the end of a runtime session associated with the runtime environment 22, following a re-boot of the computer system 18, etc.

Although the JIT IMC 26 is depicted as part of the JIT compiler 24 within the runtime environment 22, other configurations for the JIT IMC 26 are possible. For example, the JIT IMC 26 could be part of another data structure within other However, the JIT IMC 26 has a relatively limited storage capacity and, as a result, uses a data eviction policy or technique to remove cached code that is not being used with a sufficient frequency to justify consumption of its relatively scarce memory resources. There are many known cache data eviction techniques that may be employed by the JIT IMC 26. One such technique is known as the least recently used algorithm, which tends to retain (i.e., to not evict) cache data that has a relatively high probability of being used in the near future. In any event, the JIT IMC 26 may evict or eliminate cached code that is nevertheless retained in the persistent cache 30. As a result, the JIT IMC 26 typically maintains only a subset of the cached code currently stored in the persistent cache 30.

In addition to native code associated with one or more applications executed by the computer system 18, the persistent cache engine 28 may also store additional information associated with applications in the persistent cache 30. Fork example, version information associated with the applications 12, last run times/dates, last compile times/dates, etc. may be stored along with the native code for the applications 12. This additional information may be used by a persistent cache configuration manager 32, the persistent cache engine 28 and/or the JIT compiler 24 to facilitate the compilation of intermediate language code, the management of the persistent cache 30, etc.

Information may be stored in the persistent cache 30 using any desired data structure that facilitates the efficient retrieval of native code information. For example, a relational database may be used to store native code methods by type. Further, application name, method type, method name, or any combination thereof, may be used as keys for database records in the persistent cache 30. Still further, the native code information may be stored or organized in the persistent cache 30 using extensible markup language (XML) files or the like.

The persistent cache configuration manager 32 enables a user to specify when methods of classes should be recompiled. For example, the persistent cache configuration manager 32 may enable a user to specify that methods are to be recompiled following a reboot of the platform or computer system 18. Additionally or alternatively, the user may specify that methods are to be recompiled on a periodic basis such as, for example, once per week. Still further, the user may instruct the persistent cache configuration manager 32 to force a recompilation of one or more methods, regardless of whether the methods have been previously compiled. For example, in a case where new hardware is added to the platform or computer system 18, or where existing hardware is modified, the user may invoke a recompilation of one or more methods so that an application executed by the computer system 18 can use that newly added or modified hardware.

In general, the JIT compiler 24 and the persistent cache engine 28 interact so that the JIT compiler 24 compiles intermediate language code into native code needed for execution of a method only if that native code is not currently stored in either the JIT IMC 26 or the persistent cache 30. In particular, before JIT compilation of the intermediate language code associated with a method is carried out, the JIT compiler 24 first checks the JIT IMC 26 for the native code associated with that method. If the JIT compiler 24 encounters a cache miss when checking the JIT IMC 26 for the native code, the JIT compiler 24 checks the persistent cache 30 for the native code. If the JIT compiler 24 also encounters a cache miss when checking the persistent cache 30, the JIT compiler 24 compiles the intermediate language code and stores the resulting native code in the JIT IMC 26. In addition, the persistent cache engine 28 also stores newly generated native code (which has been stored in the JIT IMC 26) in the persistent cache 30.

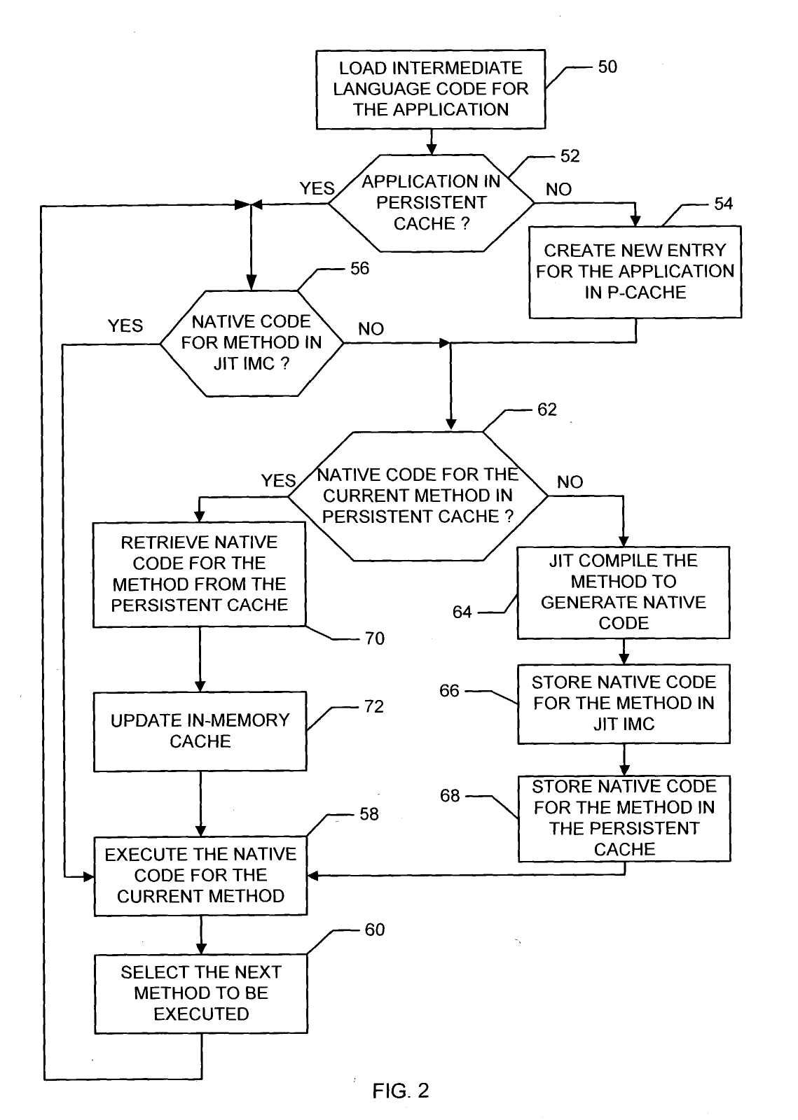

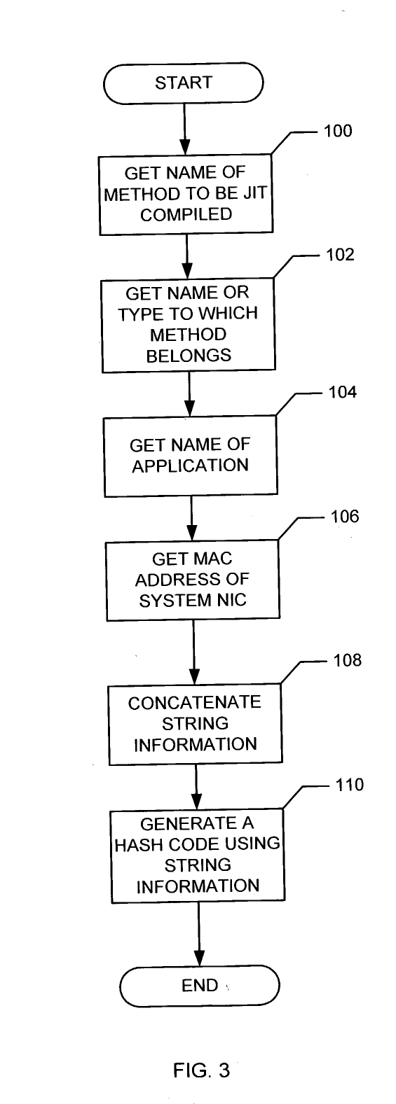

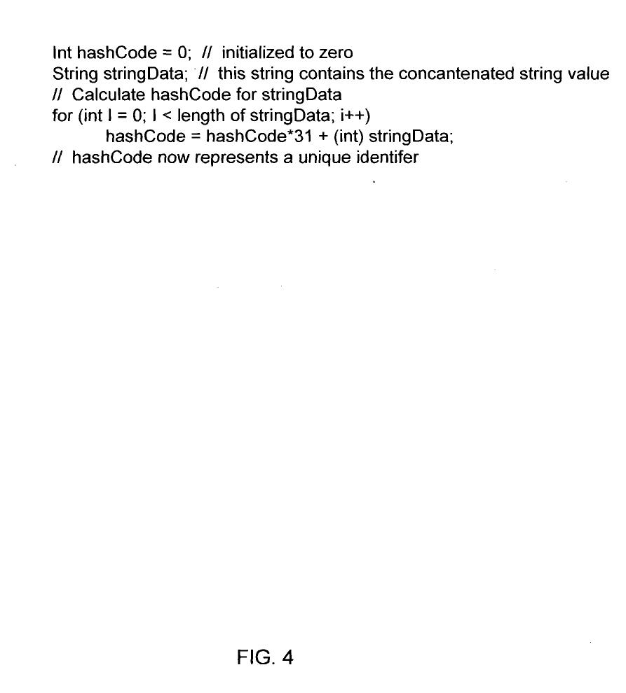

FIG. 2 is a flow diagram of an example manner in which the JIT compiler 24 and the persistent cache engine 28 may be configured to interact. As depicted in FIG. 2, a loader (not shown) within the runtime environment 22 loads intermediate language code (e.g., bytecodes) associated with a software application to be executed by the computer system or platform 18 into the runtime environment 22 (block 50). The JIT compiler 24 then determines if the loaded application has already been entered into the persistent cache 30 (i.e., one or more native code portions associated with the application have been previously stored in the persistent cache 30) (block 52). To make this determination, the JIT compiler 24 may examine a list of identifiers (which may be generated as described in connection with FIGS. 3 and 4 below) associated with applications having some or all of their native code stored in the persistent cache 30 to determine if an identifier associated with the application in question is within the list and, thus, is stored in the persistent cache 30. If the JIT compiler 24 determines that the application to be executed has not been entered into the persistent cache 30 (block 52), the JIT compiler 24 and the persistent cache engine 28 interact to create and store an entry for that application in the persistent cache (block 54). As described in greater detail in connection with FIGS. 3 and 4, the entry may include an identifier that may be used to organize information, retrieve information, etc. associated with the application.

On the other hand, if the JIT compiler 24 determines that the application in question has already been entered into the persistent cache 30 (block 52), the JIT compiler 24 then determines if native code corresponding to a method to be executed is currently stored in the JIT IMC 26 (block 56). If the native code for the current method (i.e., a method that is to be executed to carry out at least a portion of the currently loaded application) is already stored in the JIT IMC 26, the runtime environment 22 executes that native code (block 58). After executing the native code associated with the current method, the JIT compiler 24 determines the next method of the application that needs to be executed (block 60) and returns control of the runtime environment 22 to block 56.

If the JIT compiler 24 determines that the native code for the current method is not stored in the JIT IMC 26 (block 56), or if a new entry for the application has just been stored in the persistent cache 30 (block 54), the JIT compiler 24 requests the persistent cache engine 28 to determine if native code for the current method is stored in the persistent cache 30 (block 62). If the persistent cache engine 28 determines that native code for the current method is not stored in the persistent cache 30 (block 62), the JIT compiler 24 compiles the method (i.e., the intermediate language instructions corresponding to the method) into native code (block 64) and stores the newly generated native code in the JIT IMC 26 (block 66). The JIT compiler 24 then requests the persistent cache engine 28 to store the newly generated native code in the persistent cache 30 (block 68). Once the newly generated native code has been stored in the persistent cache 30, the native code is executed (block 58) and the JIT compiler 24 selects the next method to be executed (block 60).

If the native code for the current method is stored in the persistent cache 30 (block 62), the JIT compiler 24 requests the persistent cache engine 28 to retrieve the native code from the persistent cache 30 (block 70). The JIT compiler 24 receives the requested native code from the persistent cache engine 28 and updates (e.g., stores) that native code in the JIT IMC 26 (block 72). For example, the JIT compiler 24 may store the native code received from the persistent cache engine 28 in a vtable or any other suitable type of data structure. After the JIT compiler 24 has updated the JIT IMC 26 with the newly retrieved native code (block 72), that newly retrieved native code is executed (block 58). The JIT compiler 60 then selects the next method to be executed (block 60) and returns control of the runtime environment 22 to block 56.

Because any given native code portion can reside simultaneously in the JIT IMC 26 and the persistent cache 30, cache coherency or integrity between the JIT IMC 26 and the persistent cache 30 should be maintained. Thus, if an application is modified, the illustrated JIT compiler 24 considers the modified version of that application to be a new application so that a new entry for the modified application is stored in the persistent cache 30 using a technique such as, for example, that shown in FIG. 2 (block 54). As a result, when the modified application is executed by the runtime environment 22, the JIT compiler 24 compiles the methods of the application (e.g., on an as-needed basis) to generate native code sequences for these methods that are stored in the persistent cache 30. The persistent cache configuration manager 32 preferably removes or invalidates any previous or old entry for a recently modified application from the persistent cache 30.

Alternatively, a modification of an application does not necessarily result in the creation of a new entry and regeneration of native code for that application for storage in the persistent cache 30. Instead, the JIT compiler 24 and the persistent cache engine 28 can be configured to JIT compile only those methods composing the application that have been modified in some way In that case, only the updated native code is stored in the persistent cache 30. However, updating only those native code portions of an application that have been modified and that are stored in the persistent cache 30 may require the use of several parameters including, for example, the time at which the application was last compiled, a version number, or any other information suitable for use in finding and updating native code stored in the persistent cache 30.

The persistent cache 30 is preferably secured to prevent unauthorized persons from viewing and/or modifying its contents. For example, if the persistent cache 30 is not secured, an unauthorized person may be able to view information therein (e.g., configuration of the platform or computer system 18), thereby enabling the downloading of malicious code (e.g., a worm, virus, etc.) that would be difficult to detect and/or remove. To secure the persistent cache 30, a physical and/or software-based data partitioning scheme may be used. For example, in the case where the persistent cache 30 is a hard disk, a partition of the disk drive (e.g., a block or range of sectors) may be subject to security measures and used exclusively for the persistent cache 30, while another portion of the disk drive is not subject to such security measures.

Because the persistent cache 30 can store significantly more information (e.g., native code associated with one or more applications executed by the platform or computer system 18) than the JIT IMC 26, the persistent cache 30 can be used to generate audit trail information. For example, the information stored in the persistent cache 30 can be used to gather execution statistics, generate logging reports, etc. associated with one or more applications that may be executed by the computer system 18.

FIG. 3 is a flow diagram of an example manner in which the persistent cache engine 28 shown in FIG. 1 may be configured to generate unique identifiers for native code cached in the persistent cache 30. When compiling a method associated with an application, the JIT complier 24 passes the method name (block 100), the name of the type to which the method belongs (block 102) and the application name (block 104) to the persistent cache engine 28. This information is preferably conveyed to the persistent cache engine 28 as string data. However, other data types could be used instead. The persistent cache engine 28 then obtains the media access control (MAC) address from the network interface card (not shown) within the computer system 18 (block 106) and concatenates the string data obtained in blocks 100-106 to form a single string (block 108). The concatenated string is then used to generate a hash code (block 110) that is used as an identifier or key for organizing and retrieving native code data stored in the persistent cache 30.

The pseudo-code shown in FIG. 4 represents one example manner in which the hashcode may be generated. As shown in FIG. 4, a variable “hashCode” is initialized to zero and a string variable “stringData” is defined. The hash code (i.e., the value stored in the variable “hashCode”) is then computed in an iterative loop that multiplies the current hash code value by thirty-one and adds the integer portion of the variable “stringData” to the current hash code. The iterative loop executes a number of times equal to the character length of the string represented by “stringData.”

FIG. 5 is a block diagram of an example processor system 120 that may be used to implement the apparatus and methods described herein. As shown in FIG. 5, the processor system 120 includes a processor 122 that is coupled to an interconnection bus or network 124. The processor 122 may be any suitable processor, processing unit or microprocessor such as, for example, a processor from the Intel Itanium® family, Intel X-Scale® family, the Intel Pentium® family, etc. Although not shown in FIG. 5, the system 120 may be a multi-processor system and, thus, may include one or more additional processors that are identical or similar to the processor 122 and which are coupled to the interconnection bus or network 124.

The processor 122 of FIG. 5 is coupled to a chipset 128, which includes a memory controller 130 and an input/output (I/O) controller 132. As is well known, a chipset typically provides I/O and memory management functions as well as a plurality of general purpose and/or special purpose registers, timers, etc. that are accessible or used by one or more processors coupled to the chipset. The memory controller 130 performs functions that enable the processor 122 (or processors if there are multiple processors) to access a system memory 134, which may include any desired type of volatile memory such as, for example, static random access memory (SRAM), dynamic random access memory (DRAM), etc. As noted above, the system memory 134 may be used to implement the JIT IMC 26. The I/O controller 132 performs functions that enable the processor 122 to communicate with peripheral input/output (I/O) devices' 136 and 138 via an I/O bus 140. The I/O devices 136 and 138 may be any desired type of I/O device such as, for example, a keyboard, a video display or monitor, a mouse, etc. Of course, the I/O devices 136 and 138 may include the mass storage device (e.g., a disk drive) that may be used to implement the persistent cache 30. While the memory controller 130 and the I/O controller 132 are depicted in FIG. 5 as separate functional blocks within the chipset 128, the functions performed by these blocks may be integrated within a single semiconductor circuit or may be implemented using two or more separate integrated circuits.

Although certain methods and apparatus have been described herein, the scope of coverage of this patent is not limited thereto. To the contrary, this patent covers all embodiments fairly falling within the scope of the appended claims either literally or under the doctrine of equivalents.

What is claimed is:

1. A method of caching machine code, comprising:
receiving intermediate language code in a just-in-time compiler;
just-in-time compiling the intermediate language code to generate machine code;
storing the machine code in a non-persistent cache within a runtime environment; and
storing the machine code in a persistent cache coupled to the runtime environment.

2. A method as defined in claim 1, wherein receiving the intermediate language code in the just-in-time compiler includes receiving bytecodes in a compiler associated with one of a Java Virtual Machine and a Common Language Runtime.

3. A method as defined in claim 1, wherein storing the machine code in the non-persistent cache includes storing the machine code in a just-in-time in memory cache.

4. A method as defined in claim 1, wherein storing the machine code in the non-persistent cache includes storing the machine code in a cache associated with one of a Java Virtual Machine and a Common Language Runtime.

5. A method as defined in claim 1, wherein storing the machine code in the persistent cache includes storing the machine code on a mass storage device.

6. A method as defined in claim 5, wherein the mass storage device comprises a disk drive.

7. A method as defined in claim 1, wherein storing the machine code in the persistent cache coupled to the runtime environment includes generating an identifier for the machine code and storing the machine code in the persistent cache in associated with the identifier.

8. A method as defined in claim 7, wherein generating the identifier for the machine code includes using string information associated with the machine code to generate the identifier.

9. A system for caching machine code, comprising:
a runtime environment having a just-in-time compiler and a persistent cache engine; and
a persistent cache coupled to the runtime environment.

10. A system as defined in claim 9, wherein the runtime environment is based on one of a Java Virtual Machine and a Common Language Runtime.

11. A system as defined in claim 9, wherein the runtime environment is hosted by an operating system executed within a computer system.

12. A system as defined in claim 9, wherein the persistent cache comprises a disk drive.

13. A system as defined in claim 9, wherein the just-in-time compiler and the persistent cache engine cooperate to generate an identifier and store native code in the persistent cache in association with the identifier.

14. A system as defined in claim 13, wherein the identifier is based on string information associated with the native code.

15. A system as defined in claim 9, further comprising a persistent cache configuration manager.

16. A computer system, comprising:
a mass storage device; and
a processor coupled to the mass storage device and programmed to:
receive intermediate language code in a just-in-time compiler;
just-in-time compile the intermediate language code to generate machine code;
store the machine code in a cache associated with the just-in-time compiler; and
store the machine code on the mass storage device.

17. A computer system as defined in claim 16, wherein the intermediate language code includes Java bytecodes and the just-in-time compiler is associated with one of a Java Virtual Machine and a Common Language Runtime.

18. A computer system as defined in claim 16, wherein the cache associated with the just-in-time compiler is an in-memory cache.

19. A computer system as defined in claim 16, wherein the mass storage device comprises a disk drive.

20. A computer system as defined in claim 16, wherein the processor is programmed to generate an identifier and to store the machine code on the mass storage device in association with the identifier.

21. A computer system as defined in claim 20, wherein the processor is programmed to generate the identifier using string information associated with the machine code.

22. A machine accessible medium having data stored thereon that, when executed, causes a machine to:
receive intermediate language code in a just-in-time compiler;
just-in-time compile the intermediate language code to generate machine code;
store the machine code in a non-persistent cache within a runtime environment; and
store the machine code in a persistent cache coupled to the runtime environment.

23. A machine accessible medium as defined in claim 22, having data stored thereon that, when executed, causes the machine to store the machine code in the non-persistent cache by storing the machine code in a just-in-time in-memory cache within the runtime environment.

24. A machine accessible medium as defined in claim 22, having data stored thereon that, when executed, causes the machine to store the machine code in the persistent cache by generating an identifier for the machine code and storing the machine code in the persistent cache based on the identifier.

25. A method of executing a software application, comprising:
selecting a method of the software application for execution;
determining if machine code for the method is stored in a just-in-time compiler in-memory cache;
determining if the machine code for the method is stored in a persistent cache; and
executing the machine code for the method.

26. A method as defined in claim 25, further comprising:
just-in-time compiling the method to generate the machine code in response to a determination that the machine code is not stored in the persistent cache;
storing the machine code in the just-in-time compiler in-memory cache; and
storing the machine code in the persistent cache.

27. A method as defined in claim 25, further comprising:
retrieving the machine code from the persistent cache; and
updating the just-in-time compiler in-memory cache to include the machine code.

28. A method as defined in claim 27, wherein updating the just-in-time compiler in-memory cache includes updating a vtable associated with the in-memory cache.

29. A method as defined in claim 25, further comprising determining if an entry for the software application is contained within the persistent cache.

30. A method as defined in claim 29, further comprising creating the entry for the software application within the persistent cache in response to a determination that the persistent cache does not contain the entry for the software application.

31. A system for executing a software application, comprising:
a persistent cache;
a non-persistent cache; and
a processor coupled to the persistent cache and the non-persistent cache and programmed to:
select a method of the software application for execution;
determine if machine code for the method is stored in the non-persistent cache;
determine if the machine code for the method is stored in the persistent cache; and
execute the machine code for the method.

32. A system as defined in claim 31, wherein the processor is programmed to:
just-in-time compile the method to generate the machine code in response to a determination that the machine code is not stored in the persistent cache;
store the machine code in the non-persistent cache; and
store the machine code in the persistent cache.

33. A system as defined in claim 31, wherein the processor is programmed to retrieve the machine code from the persistent cache and update the non-persistent cache to include the machine code.

34. A machine accessible medium having data stored thereon that, when executed, causes a machine to:
select a method of the software application for execution;
determine if machine code for the method is stored in a non-persistent cache;
determine if the machine code for the method is stored in a persistent cache; and
execute the machine code for the method.

35. A machine accessible medium as defined in claim 34, wherein the machine accessible medium has data stored thereon that, when executed, causes the machine to:
just-in-time compile the method to generate the machine code in response to a determination that the machine code is not stored in the persistent cache;
store the machine code in the non-persistent cache; and
store the machine code in the persistent cache.

36. A machine accessible medium as defined in claim 34, wherein the machine accessible medium has data stored thereon that, when executed, causes the machine to retrieve the machine code from the persistent cache and update the non-persistent cache to include the machine code.
